(19) United States
(12) Patent Application Publication
(10) Pub. No.: US 2022/0035401 A1
(43) Pub. Date: Feb. 3, 2022

(54) WEARABLE REALITY DEVICE

(71) Applicant: James Cheng Lee, La Habra, CA (US)

(72) Inventor: James Cheng Lee, La Habra, CA (US)

(21) Appl. No.: 17/324,408

(22) Filed: May 19, 2021

Related U.S. Application Data
(60) Provisional application No. 63/058,221, filed on Jul. 29, 2020.

(30) Foreign Application Priority Data
Apr. 9, 2021 (CN) 202110380857.0

(51) Int. Cl. G06F 1/16

(52) U.S. Cl. CPC G06F 1/163

(57) ABSTRACT

A wearable reality device including a left earmuff, a right earmuff, a first connecting component, a display body, and a second connecting component is provided. The left earmuff is configured to be positioned outside the user's left ear when the user uses the wearable reality device. The right earmuff is configured to be positioned outside the user's right ear when the user uses the wearable reality device. The first connecting component connects the left earmuff and the right earmuff, and is configured to extend across a top of the user's head and be supported by the top of the user's head when the user uses the wearable reality device. The display body is configured to be positioned in front of the user's forehead and eyes when the user uses the wearable reality device. The second connecting component connects the display body and the first connecting component.

### CROSS-REFERENCE TO RELATED APPLICATION

This application claims the benefit of the U.S. Provisional Patent application No. 63/058,221, filed on Jul. 29, 2020, and CN patent application No. 202110380857.0, filed on Apr. 9, 2021, the content of which is incorporated herein by reference.

### BACKGROUND OF THE INVENTION

### 1. Field of the Invention

The disclosure relates to a reality device, and particular to a wearable reality device.

### 2. The Prior Arts

As an imagination to and a representative of the future and technological development, reality technology is developing enthusiastically. The reality technology includes virtual reality (VR), augmented reality (AR), mixed reality (MR), and the like. VR is to create a completely virtual world through devices and make people's senses to be immersed in the virtual world. AR is to add a few virtual elements to the real world through devices, one example of which is a world-famous game Pokemon GO. MR, as something in between, is to combine virtual scenes with reality through devices and give people an experience that seems to be true.

The devices for reality technology can not only be devices placed in the environment, but also be wearable devices. A common type of wearable reality device is head-mounted reality device, which has a structure similar to goggles. A belt that extends around the back of the head provides a holding force to the head of the user so as to provide a fixing effect. However, if the belt is tightened to securely fix the device, it is easy to cause discomfort to the user, and thus it is impossible to wear the device for a long time. If the belt is loosened, there may be a risk of slipping off of the device. Another common wearable reality device is glasses-type reality device, which has a structure similar to glasses. Such a device is supported by the bridge of the nose and the ears. However, over a long period of time, the weight of the device will cause a feeling of pressure, and thus it is either impossible to use the device for a long time.

### SUMMARY OF THE INVENTION

The disclosure provides a wearable reality device, which enhances the comfortability of wearing and thereby allows a long time of use compared to the existing wearable reality devices.

The wearable reality device according to the disclosure comprises a left earmuff, a right earmuff, a first connecting component, a display body, and a second connecting component. The left earmuff is configured to be positioned outside the left ear of a user when the user uses the wearable reality device. The right earmuff is configured to be positioned outside the right ear of the user when the user uses the wearable reality device. The first connecting component connects the left earmuff and the right earmuff, and the first connecting component is configured to extend across the top of the head of the user and be supported by the top of the head when the user uses the wearable reality device. The display body is configured to be positioned in front of the forehead and the eyes of the user when the user uses the wearable reality device. The second connecting component connects the display body and the first connecting component.

### BRIEF DESCRIPTION OF THE DRAWINGS

FIG. 1 is a perspective view of an exemplary wearable reality device.

FIG. 2 is a front view of the exemplary wearable reality device.

FIG. 3 is a side view of the exemplary wearable reality device.

FIG. 4 is a back view of the exemplary wearable reality device.

FIG. 5 is a top view of the exemplary wearable reality device.

FIG. 6 is a bottom view of the exemplary wearable reality device.

FIG. 7 is a perspective view of the exemplary wearable reality device in a deformed state.

FIG. 8 is a perspective view of the exemplary wearable reality device in another deformed state.

### DETAILED DESCRIPTION OF THE PREFERRED EMBODIMENTS

The disclosure provides a wearable reality device, which may be a VR device, an AR device, a MR device, or the like. It will be described more fully hereinafter with reference to accompanying drawings. It should be understood that the description and the drawings are provided for the illustrative and explaining purposes, but not for at limiting purpose. The description to the well-known embodiments and/or alternative elements in the related may be omitted to avoid obscuring the focus of the disclosure. In addition, for clarity, the attached drawings may not be drawn to scale, and some elements and/or reference numerals may be omitted in some drawings. It is appreciated that the elements and/or features in one embodiment may be incorporated in another embodiment even without further recitation.

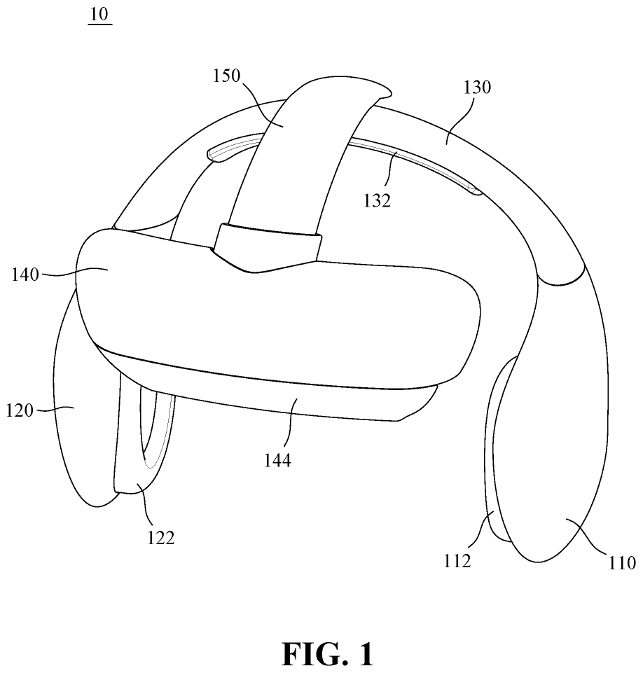

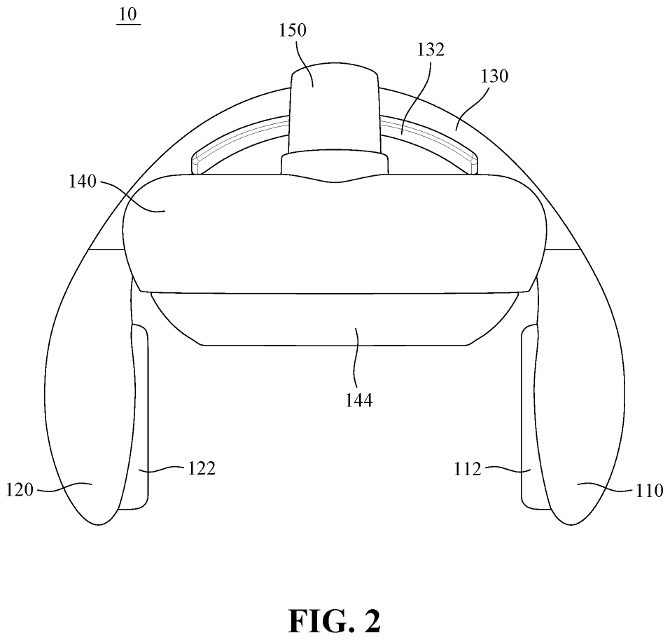

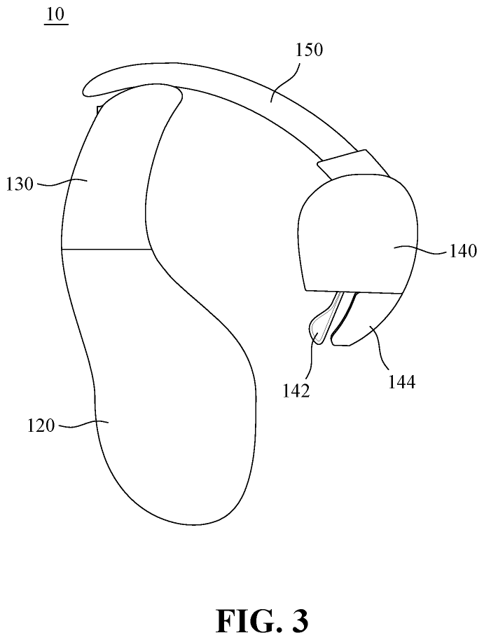

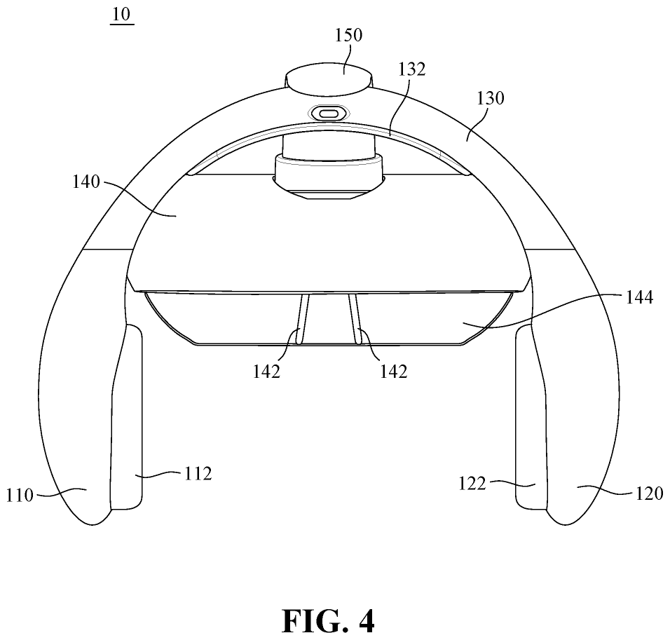

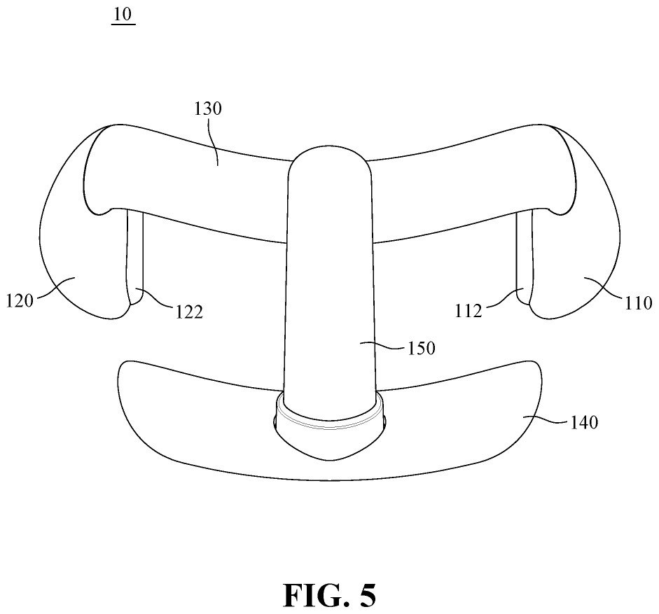

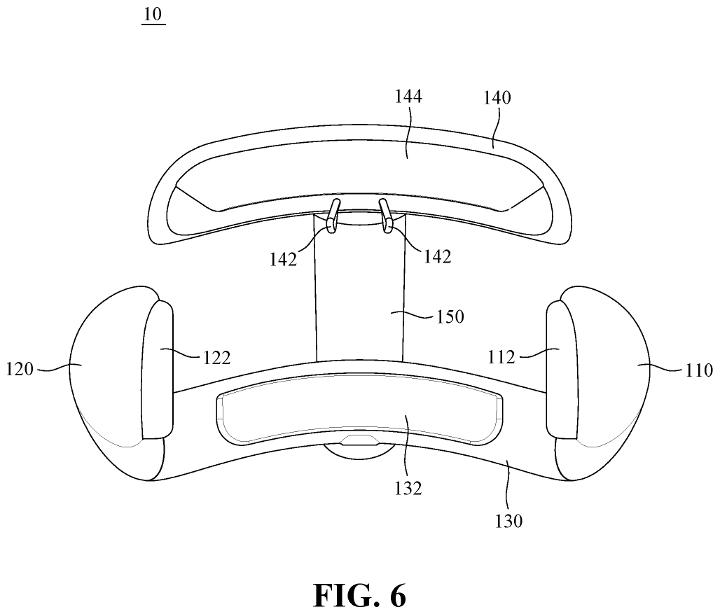

Now referring to FIG. 1 to FIG. 6, an exemplary wearable reality device is shown, wherein FIG. 1 is a perspective view of the wearable reality device 10, FIG. 2 is a front view of the wearable reality device 10, FIG. 3 is a side view of the wearable reality device 10, FIG. 4 is a back view of the wearable reality device 10, FIG. 5 is a top view of the of the wearable reality device 10, and FIG. 6 is a bottom view of the wearable reality device 10.

The wearable reality device 10 comprises a left earmuff 110, a right earmuff 120, a first connecting component 130, a display body 140, and a second connecting component 150. The left earmuff 110 is configured to be positioned outside the left ear of a user when the user uses the wearable reality device 10. The right earmuff 120 is configured to be positioned outside the right ear of the user when the user uses the wearable reality device 10. The first connecting component 130 connects the left earmuff 110 and the right earmuff 120, and the first connecting component 130 is configured to extend across the top of the head of the user and be supported by the top of the head when the user uses the wearable reality device 10. The display body 140 is configured to be positioned in front of the forehead and the eyes of the user when the user uses the wearable reality device 10. The second connecting component 150 connects the display body 140 and the first connecting component 130.

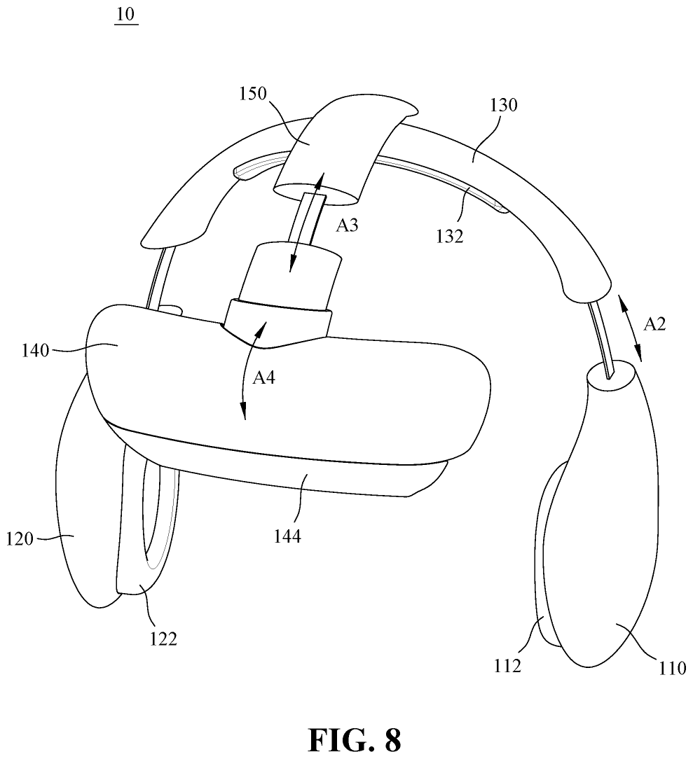

More specifically, the left earmuff 110, the right earmuff 120, and the first connecting component 130 of the wearable reality device 10 may form a structure substantially similar to headphones. According to some embodiments, the left earmuff 110 may comprise a pad 112, and the right earmuff may comprise a pad 122. The pad 112 and the pad 122 can provide comfortability to the user when the user uses the wearable reality device 10. According to some embodiments, the first connecting component 130 may comprise a lining 132. The lining 132 can provide comfortability to the user and increase frictional force to further prevent slipping off of the wearable reality device 10 when the user uses the wearable reality device 10. In some embodiments, the first connecting component 130 is rigid, i.e., the first connecting component 130 is not an object that is easily bendable like a belt, at least most of a shell of the first connecting component 130 or even entire of the shell is made of an inflexible material, for example, the first connecting component 130 may have a plastic shell. As such, the first connecting component 130 has a certain mechanical strength, which is beneficial for stability of the overall structure and for transmission and provision of supporting force. In some embodiments, also referring to FIG. 8, the first connecting component 130 may further comprise a length adjusting member, which is configured to adjust a length of the first connecting component 130 based on the shape of the head of the user, as indicated by a double arrow A2. In some embodiments, the left earmuff 110, the right earmuff 120, and the first connecting component 130 may substantially incorporate components of a headphone, and be used as a headphone.

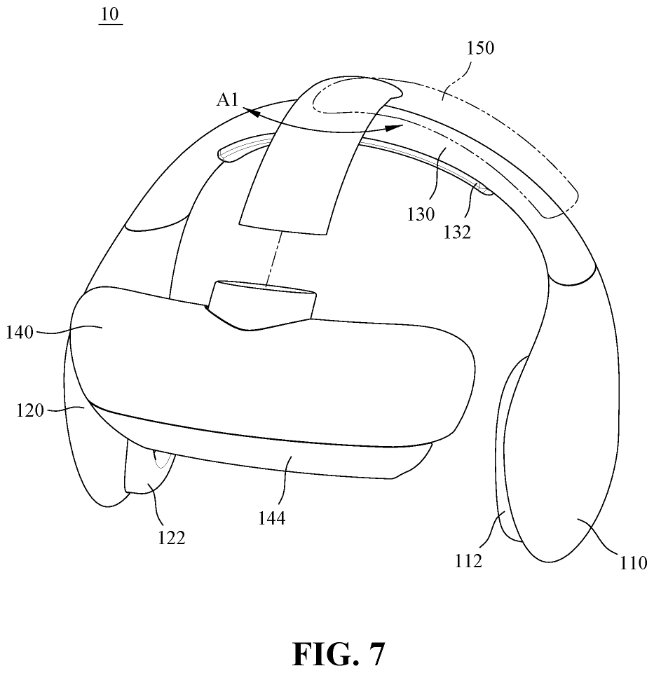

The display body 140 is a main body for providing reality, and it may include most of related components. According to the type (VR, AR, or MR) of the wearable reality device 10, the display body 140 may comprise different components and have different appearance, the related description is omitted to avoid obscuring the focus of the disclosure. According to some embodiments, the display body 140 may be further configured to lean against the forehead of the user when the user uses the wearable reality device 10. According to some embodiments, the display body 140 may comprise a nose pad portion 142, which is used as a supporting component on the nose bridge. The nose pad portion 142 may be provided as an additionally attached component, as shown in FIG. 3 and FIG. 6. The nose pad portion 142 may alternatively formed integrally with other portions of the display body 140 like the nose pads of common plastic frame glasses. According to some embodiments the display body 140 may comprise a window portion 144, and the window portion 144 is transparent. This is beneficial if the wearable reality device 10 is provided as an AR device or a MR device. In some embodiments, also referring to FIG. 7, the display body 140 is detachable with respect to the second connecting component 150. In some embodiments, also referring to FIG. 8, the display body 140 is rotatable with respect to the second connecting component 150, as indicated by a double arrow A4.

The second connecting component 150 connects the display body 140 to the first connecting component 130. According to some embodiments, the second connecting component 150 may be connected to a central part of the first connecting component 130, such as to a top of the central part of the first connecting component 130. The second connecting component 150 may be further configured to partially positioned on the top of the head of the user and be supported by the top of the head when the user uses the wearable reality device 10. Similar to the first connecting component 130, in some embodiments, the second connecting component 150 may be rigid, and this is beneficial for stability of the overall structure and for transmission and provision of supporting force. In some embodiments, also referring to FIG. 8, the second connecting component 150 may further comprise a length adjusting member, which is configured to adjust a length of the second connecting component 150 based on the shape of the head of the user, as indicated by a double arrow A3. In some embodiments, also referring to FIG. 7 the second connecting component 150 is rotatable with respect to the first connecting component 130, as indicated by a double arrow A1.

For the wearable reality device 10, sources of holding and supporting force includes a holding force provided by the left earmuff 110 and the right earmuff 120 and a supporting force provided by the top of the head when the first connecting component 130 is positioned on the top of the head, and may further include a supporting force provided by the top of the head when the(second connecting component 150 is partially positioned on the top of the head, a holding force provided by the forehead when the display body 140 lean against the forehead, and a bearing force provided by the nose bridge when the nose pad portion 142 is positioned on the nose bridge. The various force sources distributing on the head disperse the burden of each force source. As such, compared to the existing wearable reality device, the wearable reality device of the disclosure can enhance comfortability of wearing, and thereby allows a long time of use.

While the embodiments have been provided as above, they are used to limit the disclosure. It will be apparent to those skilled in the art that various modifications and variations can be made to the disclosed embodiments without departing from the spirit and the scope of the disclosure. The scope of the disclosure should be indicated by the following claims.

What is claimed is:

1. A wearable reality device, comprising:
a left earmuff configured to be positioned outside the left ear of a user when the user uses the wearable reality device;
a right earmuff configured to be positioned outside the right ear of the user when the user uses the wearable reality device;
a first connecting component connecting the left earmuff and the right earmuff, the first connecting component configured to extend across the top of the head of the user and be supported by the top of the head when the user uses the wearable reality device;
a display body configured to be positioned in front of the forehead and the eyes of the user when the user uses the wearable reality device; and
a second connecting component connecting the display body and the first connecting component.

2. The wearable reality device according to claim 1, wherein the second connecting component is connected to a central part of the first connecting component.

3. The wearable reality device according to claim 1, wherein the left earmuff comprises a pad, the right earmuff comprises a pad, and the first connecting component comprises a lining.

4. The wearable reality device according to claim 1, wherein the display body comprises a nose pad portion.

5. The wearable reality device according to claim 1, wherein the display body comprises a window portion, and the window portion is transparent.

6. The wearable reality device according to claim 1, wherein the display body is detachable with respect to the second connecting component, and/or wherein the display body is rotatable with respect to the second connecting component.

7. The wearable reality device according to claim 1, wherein the second connecting component is rotatable with respect to the first connecting component.

8. The wearable reality device according to claim 1, wherein the first connecting component comprises a length adjusting member, and the second connecting component comprises a length adjusting member.

9. The wearable reality device according to claim 1, wherein the first connecting component is rigid, and the second connecting component is rigid.

10. The wearable reality device according to claim 1, being a VR device, an AR device, or a MR device.
